(19) United States
(12) Patent Application Publication
(10) Pub. No.: US 2014/0255029 A1
(43) Pub. Date: Sep. 11, 2014

(54) ORTHOGONAL FREQUENCY-DIVISION MULTIPLEXING BURST MARKERS

(71) Applicant: QUALCOMM Incorporated, San Diego, CA (US)

(72) Inventors: Nicola Varanese, Nuremberg (DE); Hendrik Schoeneich, Heroldsberg (DE); Christian Pietsch, Heroldsberg (DE); Christoph Arnold Joetten, Wadern (DE); Andrea Garavaglia, Nuremberg (DE); Stefan Brueck, Neunkirchen am Brand (DE); Juan Montojo, Nuremberg (DE)

(73) Assignee: QUALCOMM Incorporated, San Diego, CA (US)

(21) Appl. No.: 14/084,310

(22) Filed: Nov. 19, 2013

Related U.S. Application Data
(60) Provisional application No. 61/773,074, filed on Mar. 5, 2013.
(60) Provisional application No. 61/774,502, filed on Mar. 7, 2013.
(60) Provisional application No. 61/800,625, filed on Mar. 15, 2013.

(51) Int. Cl. H04B 10/27; H04L 27/26

(52) U.S. Cl. CPC H04B 10/27; H04L 27/2626
USPC 398/66

(57) ABSTRACT

A coax network unit (CNU) receives downstream bursts from a coax line terminal (CLT) and transmits upstream bursts to the CLT. The downstream bursts include start markers that indicate the beginnings of the downstream bursts and may also include pilot symbols. The downstream bursts are continuous across available resource elements in a matrix of subcarriers and orthogonal frequency-division multiplexing (OFDM) symbols. The available resource elements exclude resource elements in the matrix that carry the pilot symbols. The upstream bursts may include start markers indicating the beginnings of the upstream bursts and end markers indicating the ends of the upstream bursts. Respective upstream bursts are transmitted in respective groups of one or more resource blocks allocated to the CNU.

### RELATED APPLICATIONS

This application claims priority to U.S. Provisional Patent Applications No. 61/773,074, titled “OFDM Pilot and Frame Structures,” filed Mar. 5, 2013; No. 61/774,502, titled “OFDM Burst Markers,” filed Mar. 7, 2013; and No. 61/800,625, titled “OFDM Burst Markers,” filed Mar. 15, 2013, all of which are hereby incorporated by reference in their entirety.

### TECHNICAL FIELD

The present embodiments relate generally to communication systems, and specifically to orthogonal frequency-division multiplexing (OFDM).

### BACKGROUND OF RELATED ART

The Ethernet Passive Optical Networks (EPON) protocol may be extended over coaxial (coax) links in a cable plant. The EPON protocol as implemented over coax links is called EPON Protocol over Coax (EPoC). Implementing an EPoC network or similar network over a cable plant presents significant challenges. For example, there is a need for efficient and effective arrangements of upstream and downstream transmission bursts.

### SUMMARY

Embodiments are disclosed in which bursts transmitted between a coax line terminal (CLT) and coax network units (CNUs) include start markers and/or end markers.

In some embodiments, a method of data communication is performed at a CNU coupled to a CLT. In the method, the CNU receives from the CLT downstream bursts that include start markers indicating the beginnings of the downstream bursts and also include pilot symbols. The downstream bursts are continuous across available resource elements in a matrix of subcarriers and OFDM symbols. The available resource elements exclude resource elements in the matrix that carry the pilot symbols.

In some embodiments, a CNU includes a receiver to receive downstream bursts that include start markers indicating the beginnings of the downstream bursts and also include pilot symbols. The downstream bursts are continuous across available resource elements in a matrix of subcarriers and OFDM symbols. The available resource elements exclude resource elements in the matrix that carry the pilot symbols.

### BRIEF DESCRIPTION OF THE DRAWINGS

The present embodiments are illustrated by way of example and are not intended to be limited by the figures of the accompanying drawings.

FIG. 1A is a block diagram of a coaxial network in accordance with some embodiments.

FIG. 1B is a block diagram of a network that includes both optical links and coax links in accordance with some embodiments.

FIG. 2 is a block diagram of a system in which a coax line terminal is coupled to a coax network unit in accordance with some embodiments.

FIGS. 3A and 3B show examples of resource blocks in accordance with some embodiments.

FIG. 3C shows an example of pilot symbol placement in a resource block in accordance with some embodiments.

FIGS. 4A and 4B shows frames generated using resource blocks of the type shown in FIG. 3C in accordance with some embodiments.

FIG. 5A illustrates the effect of phase changes and transfer function changes on resource elements in a resource block in accordance with some embodiments.

FIGS. 5B and 5C show examples of marker placement in a resource block in accordance with some embodiments.

FIGS. 6A-6D show additional examples of marker placement in accordance with some embodiments.

FIG. 7 is a block diagram of an upstream transmitter in accordance with some embodiments.

FIGS. 8A and 8B are block diagrams of upstream receivers in accordance with some embodiments.

FIG. 9 shows an example of marker detection in accordance with some embodiments.

FIG. 10A shows continual pilot symbols for downstream transmissions in accordance with some embodiments.

FIGS. 10B and 10C show bursts in downstream transmissions in accordance with some embodiments.

FIG. 11 is a block diagram of a downstream transmitter in accordance with some embodiments.

FIG. 12 is a block diagram of a downstream receiver in accordance with some embodiments.

FIG. 13 is a flowchart showing a method of communication between a coax line terminal and coax network unit in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

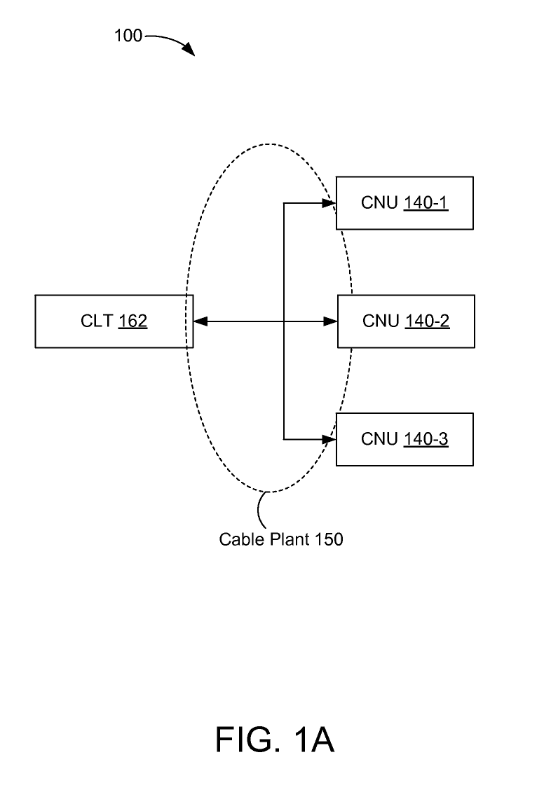

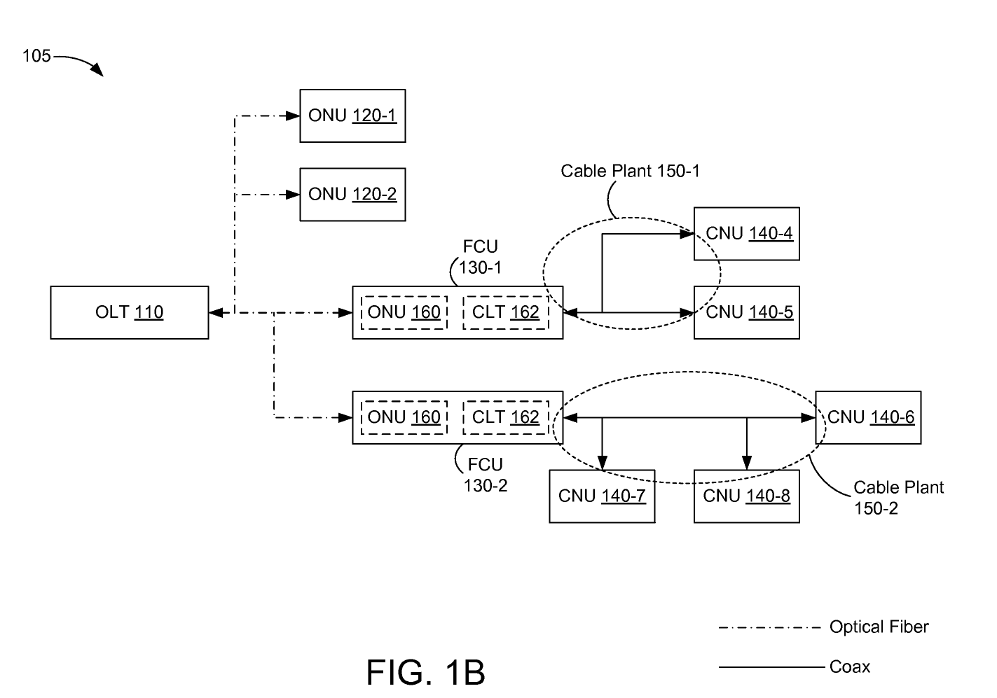

FIG. 1A is a block diagram of a coaxial (coax) network 100 (e.g., an EPoC network) in accordance with some embodiments. The network 100 includes a coax line terminal (CLT) 162 (also referred to as a coax link terminal) coupled to a plurality of coax network units (CNUs) 140-1, 140-2, and 140-3 via coax links. A respective coax link may be a passive coax cable, or may also include one or more amplifiers and/or equalizers, and may run through one or more splitters and/or taps. The coax links compose a cable plant 150. In some embodiments, the CLT 162 is located at the headend of the cable plant 150 and the CNUs 140 are located at the premises of respective users. Alternatively, the CLT 162 is located within the cable plant 150.

The CLT 162 transmits downstream signals to the CNUs 140-1, 140-2, and 140-3 and receives upstream signals from the CNUs 140-1, 140-2, and 140-3. In some embodiments, each CNU 140 receives every packet transmitted by the CLT 162 and discards packets that are not addressed to it. The CNUs 140-1, 140-2, and 140-3 transmit upstream signals using coax resources specified by the CLT 162. For example, the CLT 162 transmits control messages (e.g., GATE messages) to the CNUs 140-1, 140-2, and 140-3 specifying respective future times at which and respective frequencies on which respective CNUs 140 may transmit upstream signals. The bandwidth allocated to a respective CNU by a control message may be referred to as a grant. In some embodiments, the downstream and upstream signals are transmitted using orthogonal frequency-division multiplexing (OFDM). For example, the downstream and upstream signals are orthogonal frequency-division multiple access (OFDMA) signals.

In some embodiments, the CLT 162 is part of a fiber-coax unit (FCU) 130 that is also coupled to an optical line terminal (OLT) 110, as shown in FIG. 1B. FIG. 1B is a block diagram of a network 105 that includes both optical links and coax links in accordance with some embodiments. In the network 105, the OLT 110 (also referred to as an optical link terminal) is coupled to a plurality of optical network units (ONUs) 120-1 and 120-2 via respective optical fiber links. The OLT 110 also is coupled to a plurality of fiber-coax units (FCUs) 130-1 and 130-2 via respective optical fiber links. FCUs are also referred to as optical-coax units (OCUs).

In some embodiments, each FCU 130-1 and 130-2 includes an ONU 160 coupled with a CLT 162. The ONU 160 receives downstream packet transmissions from the OLT 110 and provides them to the CLT 162, which forwards the packets to the CNUs 140 (e.g., CNUs 140-4 and 140-5, or CNUs 140-6 through 140-8) on its cable plant 150 (e.g., cable plant 150-1 or 150-2). In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1B, the first FCU 130-1 communicates with CNUs 140-4 and 140-5 (e.g., using OFDMA), and the second FCU 130-2 communicates with CNUs 140-6, 140-7, and 140-8 (e.g., using OFDMA). The coax links coupling the first FCU 130-1 with CNUs 140-4 and 140-5 compose a first cable plant 150-1. The coax links coupling the second FCU 130-2 with CNUs 140-6 through 140-8 compose a second cable plant 150-2. A respective coax link may be a passive coax cable, or alternately may include one or more amplifiers and/or equalizers, and may run through one or more splitters and/or taps. In some embodiments, the OLT 110, ONUs 120-1 and 120-2, and optical portions of the FCUs 130-1 and 130-2 are implemented in accordance with the Ethernet Passive Optical Network (EPON) protocol.

In some embodiments, the OLT 110 is located at a network operator's headend, the ONUs 120 and CNUs 140 are located at the premises of respective users, and the FCUs 130 are located at the headends of their respective cable plants 150 or within their respective cable plants 150.

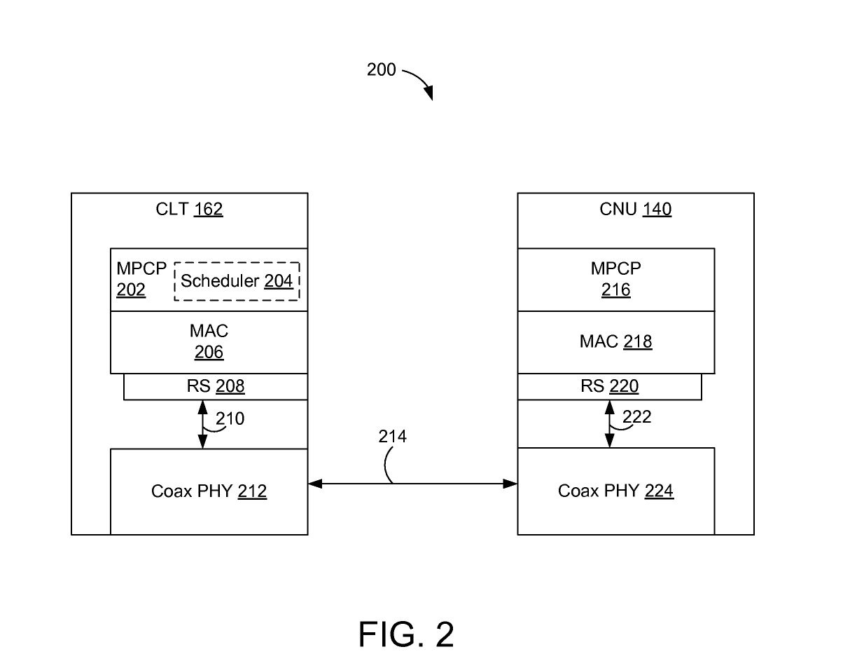

FIG. 2 is a block diagram of a system 200 in which a CLT 162 is coupled to a CNU 140 (e.g., one of the CNUs 140-1 through 140-8, FIGS. 1A-1B) by a coax link 214 (e.g., in a cable plant 150, such as the cable plant 150-1 or 150-2, FIGS. 1A-1B) in accordance with some embodiments. The CLT 162 and CNU 140 communicate via the coax link 214. The coax link 214 couples a coax physical layer device (PHY) 212 in the CLT 162 to a coax PHY 224 in the CNU 140.

The coax PHY 212 in the CLT 162 is coupled to a media access controller (MAC) 206 (e.g., a full-duplex MAC) by a media-independent interface 210 (e.g., a 10 Gigabit Media Independent Interface (XGMII)) and a reconciliation sublayer (RS) 208. The MAC 206 is coupled to a multi-point control protocol (MPCP) implementation 202, which includes a scheduler 204 that schedules downstream and upstream transmissions.

The coax PHY 224 in the CNU 140 is coupled to a MAC 218 (e.g., a full-duplex MAC) by a media-independent interface 222 and an RS 220. The MAC 218 is coupled to an MPCP implementation 216 that communicates with the MPCP implementation 202 to schedule upstream transmissions (e.g., by sending REPORT messages to the MPCP 202 implementation and receiving GATE messages in response).

In some embodiments, the MPCP implementations 202 and 216 are implemented as distinct sub-layers in the respective protocol stacks of the CLT 162 and CNU 140. In other embodiments, the MPCP implementations 202 and 216 are respectively implemented in the same layers or sub-layers as the MACs 206 and 218.

In some embodiments, frames (or portions thereof) may be constructed from resource blocks (also referred to as physical resource blocks). For example, frames (or portions thereof) for upstream transmissions from CNUs 140 to a CLT 162 may be constructed from resource blocks, in accordance with orthogonal frequency-division multiple access (OFDMA). A resource block is the smallest unit of combined time and frequency resources that can be allocated to a CNU 140. In some embodiments, resource blocks are allocated in their entirety to respective CNUs 140, such that resource blocks are not shared among CNUs 140. Each resource block includes a specified number of subcarriers and has a duration equal to the length of a specified number of OFDM symbols. For each OFDM symbol, each subcarrier in a resource block may carry a distinct symbol. A particular subcarrier within a particular OFDM symbol may be referred to as a resource element; a resource block is thus a matrix of resource elements. The size of this matrix (i.e., the number of subcarriers and OFDM symbols per resource block) may vary from cable plant 150 to cable plant 150 and may be configurable. In some embodiments, all CNUs 140 have the same number of OFDM symbols per resource block. Multiple resource blocks in a frame may be assigned to a particular CNU 140. Also, different resource blocks (or groups of resource blocks) in a frame may be assigned to different CNUs 140 (e.g., using OFDMA).

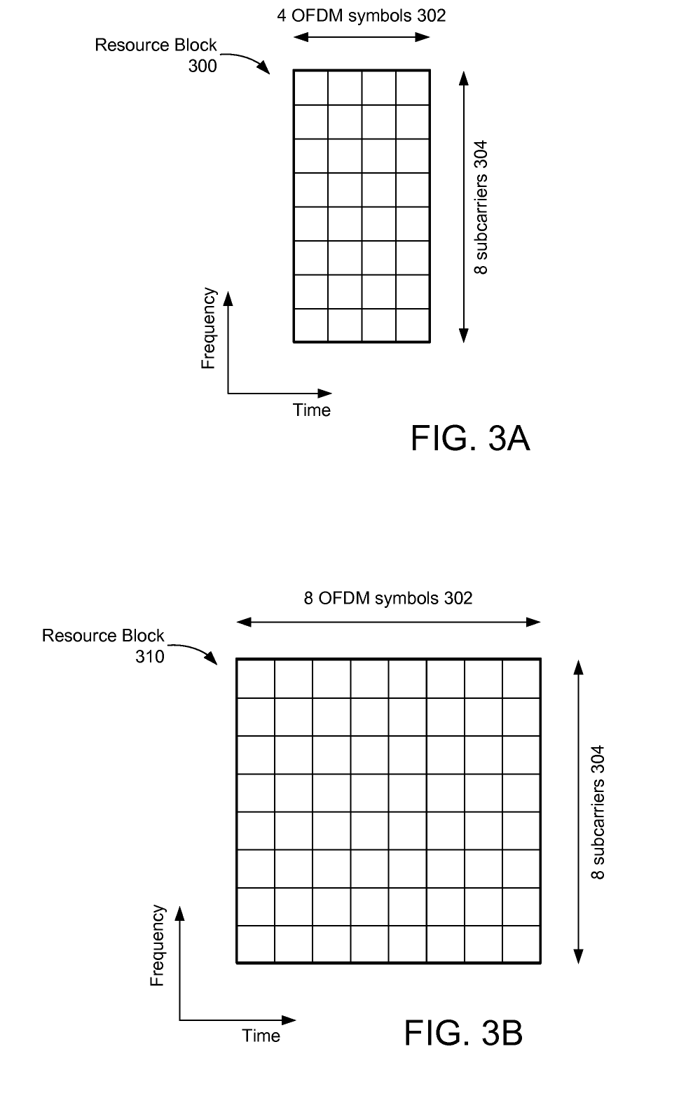

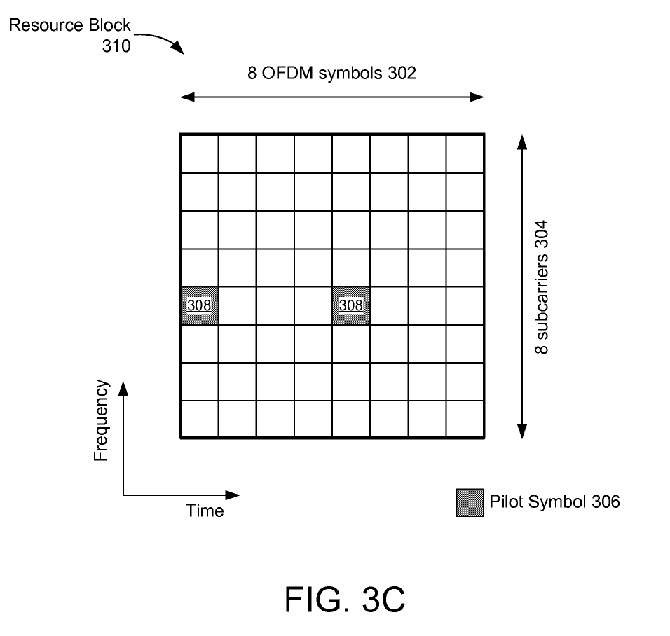

FIGS. 3A and 3B show examples of resource blocks 300 and 310 in accordance with some embodiments. In these examples, each of the resource blocks 300 and 310 includes eight subcarriers 304. The resource block 300 (FIG. 3A) has a length of four OFDM symbols 302; the resource block 310 (FIG. 3B) has a length of eight OFDM symbols 302. Other examples of resource block lengths include, but are not limited to, 16 or 32 OFDM symbols. The resource block length may be configurable (e.g., on a cable plant by cable plant basis). In some embodiments, resource blocks have a length of one or two OFDM symbols (e.g., if time interleaving is not performed). In some embodiments, the length of the resource block corresponds to the depth of the time interleaver.

FIG. 3C shows an example of pilot symbol placement in the resource block 310 (FIG. 3B) in accordance with some embodiments. Pilot symbols 306 are placed on specified resource elements 308 in the resource block 310. In some embodiments, the specified resource elements 308 that carry pilot symbols 306 are on a single subcarrier 304 in the resource block 310, such that the number of subcarriers 304 in the resource block 310 determines the frequency spacing of pilot symbols 306 in a frame. In some embodiments, the pilot symbols 306 are placed on OFDM symbols 302 such that the OFDM symbols 302 carrying pilot symbols 306 in successive frames are evenly spaced. In some embodiments, the pilot symbols 306 are quadrature phase-shift keying (QPSK) constellation points (e.g., derived from pseudo-random sequences). In some embodiments, resource blocks (e.g., the resource block 300, FIG. 3A, or 310, FIGS. 3B-3C) are mirrored about a DC subcarrier (e.g., which is left empty) when constructing frames, such that pilot symbols 306 are symmetric about the DC subcarrier.

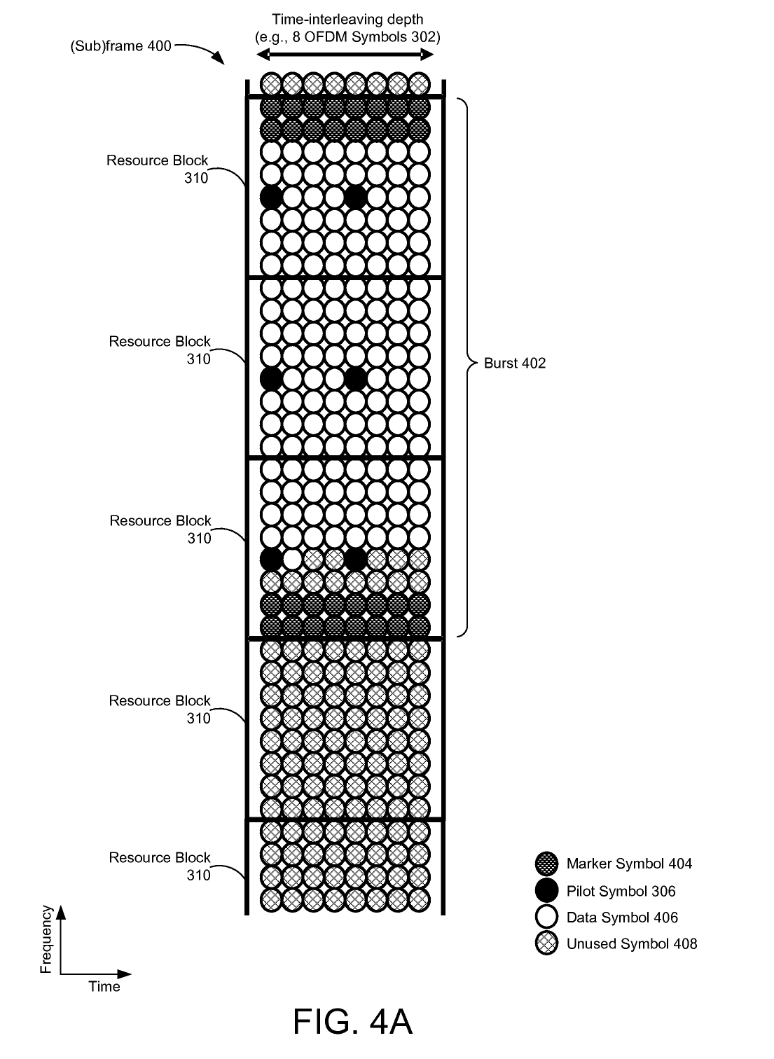

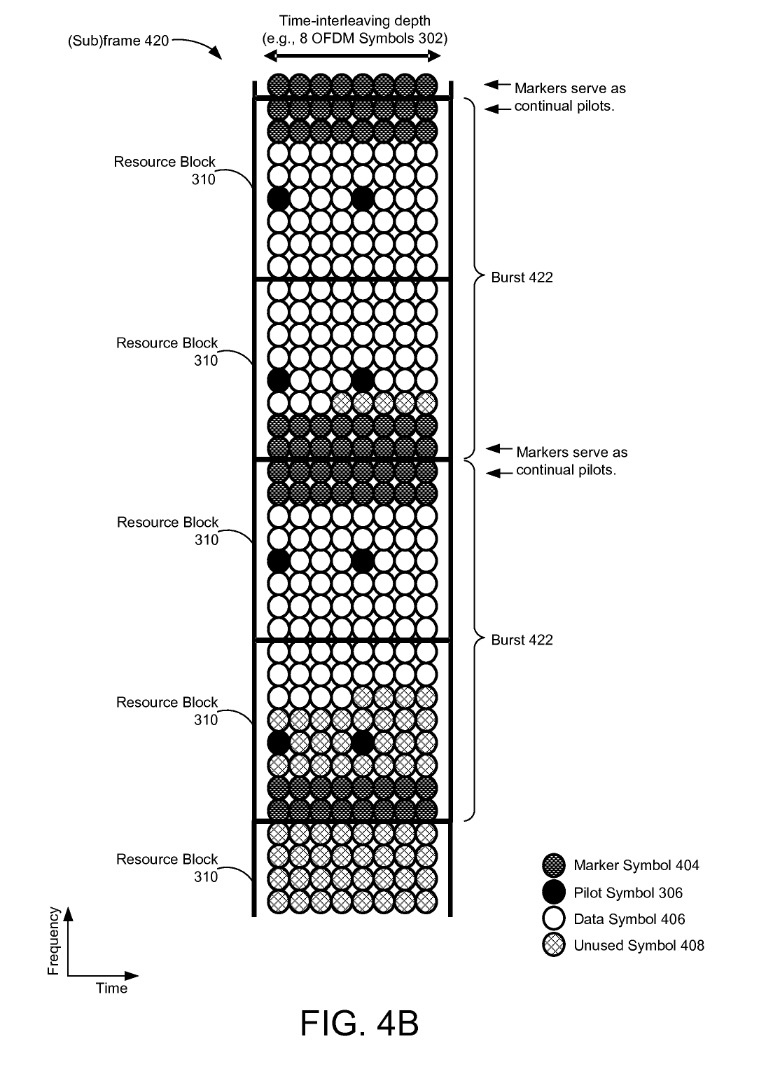

FIG. 4A shows a portion of a frame (or subframe) 400 generated using resource blocks 310 (FIGS. 3B-3C) in accordance with some embodiments. (Each column corresponds to a distinct OFDM symbol 302; each row corresponds to a distinct subcarrier 304.) The spacing of the pilot symbols 306 in the resource block of FIG. 3C results in evenly spaced regular pilot symbols 306 in the resource blocks 310 that carry data. In some embodiments, the (sub)frame 400 is used for upstream transmissions from CNUs 140 to a CLT 162.

A grant of bandwidth to a specific CNU 140 includes an integer number of resource blocks (e.g., resource blocks 300, FIG. 3A, or 310, FIGS. 3B-3C), such that the CNU 140 may use the subcarriers in the resource blocks to transmit upstream. An upstream transmission by a respective CNU 140 is referred to as a burst. (The term burst may also refer to distinct downstream transmissions by a CLT 162.) In the burst 402 of FIG. 4A, a specified number of marker symbols 404 are placed at the beginning and end of the burst 402. The marker symbols 404 placed at the beginning of the burst 402 compose a start marker. The marker symbols 404 placed at the end of the burst 402 compose an end marker. The start and end markers thus each include a specified number of modulated symbols (e.g., 16 or 32). In general, each marker is a known sequence of modulated symbols. In this example, the start and end markers are respectively placed on the first two and last two subcarriers 304 of the burst.

In the example of FIG. 4A, the burst 402 does not use every resource element of the three resource blocks 310 allocated for the burst. The remaining resource elements go unused, and thus carry unused symbols 408. Each unused symbol 408 thus corresponds to an unused resource element. Also, the resource elements in resource blocks 310 adjacent to the burst 402 may be unused, such that not all resource blocks 310 are used for upstream transmissions. In some embodiments, pilot symbols 306 are not included in unused resource blocks 310, as shown in FIG. 4A: because unused resource blocks 310 are not allocated to particular CNUs 140, no CNU 140 is assigned to transmit the pilot symbols 306 in the unused resource blocks 310. Upstream transmissions thus may be discontinuous with respect to available resource elements (e.g., with respect to resource elements that are not used for pilot symbols 306) and therefore are not back-to-back. In some embodiments, the symbols 406 that carry data (“data symbols 406”) are quadrature amplitude modulation (QAM) symbols (e.g., 1024-QAM symbols).

In FIG. 4B, two adjacent groups of resource blocks 310, with two resource blocks 310 per group, are used for bursts 422 in a (sub)frame 420. For example, each burst 422 is transmitted upstream by a respective CNU 140 (e.g., in accordance with OFDMA). However, not every resource element with each group of resource blocks 310 is used, because the size of each burst 422 is smaller than the total available resources for each group of resource blocks 310. The upstream transmissions of FIG. 4B therefore are also discontinuous with respect to available resource elements and are not back-to-back.

The placement of marker symbols 404 on respective resource elements of the (sub)frames 400 (FIG. 4A) and 420 (FIG. 4B) indicates that the marker symbols 404 (and thus the markers that they compose) share coax resources with data symbols 406: the markers are not transmitted on a dedicated control channel, but instead are transmitted as part of OFDM frames.

In some embodiments, marker symbols 404 are defined using a ternary alphabet of −1, 0, and +1. The marker symbols 404 may be detected non-coherently, which may involve taking the square of each marker symbol 404. Alternatively, marker symbols 404 are defined according to other modulation techniques. For example, marker symbols 404 may be defined as QAM symbols or differentially modulated QPSK symbols. In the latter case, respective QPSK symbols in a subcarrier 304 may use a previous symbol in the subcarrier 304 (that is, a symbol on the subcarrier 304 in a previous OFDM symbol 302) as a reference for modulation, and a first symbol in the subcarrier 304 (e.g., a symbol on the subcarrier 304 in the first OFDM symbol 302 of a frame) may use a symbol from an adjacent subcarrier 304 (e.g., the second symbol on the previous subcarrier 304) as a reference for modulation.

A marker sequence m of length L, where L equals the number of marker symbols 404 to be included in a marker and thus the number of resource elements to be used for a marker, may be defined as

m=[m[0] . . . m[l] . . . m[L−1]] (1)

where m[0], m[l], and m[L−1] are respective elements of the marker sequence m and l is an integer between 0 and L−1 that indexes a respective element of the marker sequence m. In some embodiments, each element of the marker sequence m is a complex number with unitary amplitude. In some embodiments, each element of the marker sequence m is chosen so that the marker sequence m is a Hadamard sequence. In some embodiments, each element of the marker sequence m is chosen so that the marker sequence is a Zadoff-Chu sequence. A marker s can be generated to be equal to the marker sequence m:

s=m (2)

where successive elements of the marker s represent (i.e., specify the values of) successive marker symbols 404 in the marker s. For example, markers for downstream transmissions may be generated in this manner.

Alternatively, the marker sequence m defines phase changes between successive marker symbols 404 of a marker s, starting from a reference phase p:

s=[p·m[0]s[0]·m[1]s[1]·m[2] . . . s[L−2]·m[L−1]] (3)

where s[0] is a first element (i.e., p·m[0]) and thus a first marker symbol 404 of s, s[1] is a second element (i.e., s[0]·m[1]) and thus a second marker symbol 404 of s, and so on. This technique of generating a marker s thus corresponds to a form of differential phase modulation. This technique may be used, for example, for upstream transmissions. In some embodiments, the term p corresponds to a particular pilot symbol 306 used as a phase reference. The reference pilot symbol 306 is included among the modulated symbols on the resource elements of the burst (e.g., burst 402, FIG. 4A, or 422, FIG. 4B) to which the marker s is related (e.g., the burst for which the marker s serves as a start marker or end marker). In some embodiments, the phase reference term p for the start marker corresponds to the first pilot symbol 306 (e.g., the pilot symbol 306 with the lowest subcarrier index) in one of the OFDM symbols 302 of the burst (e.g., the first OFDM symbol 302 of the burst). In some embodiments, the phase reference term p for the end marker corresponds to the last pilot symbol 306 (e.g., the pilot symbol 306 with the highest subcarrier index) in one of the OFDM symbols 302 of the burst (e.g., the first OFDM symbol 302 of the burst).

In some embodiments, multiple profiles are used in a cable plant 150. Each profile specifies a modulation and coding scheme (MCS) or set of MCSs to be used for upstream and/or downstream transmissions. A profile may specify that all subcarriers 304 use the same MCS. Alternatively, a profile may specify that different subcarriers 304 use different MCSs. For example, each subcarrier 304 may be independently assigned an MCS in a process referred to as bitloading. Different profiles may be assigned to different CNUs 140 (e.g., depending on channel conditions). Each CNU 140 may be assigned one or more profiles.

In the case of multiple profiles, a specific marker may be defined for each profile that may possibly be active. For example, markers for different profiles may be defined such that they are uncorrelated (i.e., orthogonal) signals:

$${\sum }_{l = 0}^{L} {s}_{i} [ l ] \cdot {s}_{j}^{*} [ l ] = \{ \begin{matrix}L , & i = j \\ 0 , & i \neq j\end{matrix} \qquad ( 4 )$$

where i and j are indices for profiles, sᵢ is a marker for a profile with index i, and sⱼ is a marker for a profile with an index j. If the marker symbols 404 are taken from a ternary alphabet, markers are orthogonal once the square of their marker symbols 404 is taken (i.e., after non-coherent detection):

$${\sum }_{l = 0}^{L} {\vert {s}_{i} [ l ] \vert}^{2} \cdot {\vert {s}_{j}^{*} [ l ] \vert}^{2} = \{ \begin{matrix}L , & i = j \\ 0 , & i \neq j .\end{matrix} \qquad ( 5 )$$

For example, a first profile may have an associated 8-symbol marker {+1, 0, −1, −1, 0, 0, +1, +1} and a second profile may have an associated 8-symbol marker {0, −1, 0, 0, +1, +1, 0, 0}. For differential QPSK, orthogonal sequences may also be chosen for different profiles: markers may be chosen that result in orthogonal sequences after differential demodulation. If marker symbols 404 are generated from a marker sequence, the marker sequences for different profiles can be chosen to be orthogonal:

$${\sum }_{l = 0}^{L} {m}_{i} [ l ] \cdot {m}_{j}^{*} [ l ] = \{ \begin{matrix}L , & i = j \\ 0 , & i \neq j .\end{matrix} \qquad ( 6 )$$

If marker sequences are unitary modulus sequences, the above equation can be written as

$${\sum }_{l = 0}^{L} {m}_{i} [ l ] \cdot {m}_{j}^{*} [ l ] = {\sum }_{l = 0}^{L} {e}^{j ( {μ}_{i} [ l ] - {μ}_{j} [ l ] )} = \{ \begin{matrix}L , & i = j \\ 0 , & i \neq j\end{matrix} \qquad ( 7 )$$

where μᵢ[l] is the phase of the l-th element in the i-th sequence.

Detection of a particular marker signals the start or the end of a burst for the corresponding profile. In some embodiments, the same marker delimits the start and end of a burst, such that start and end markers for a particular profile are identical. In other embodiments, end markers may be omitted (e.g., with different profiles using different start markers). For example, end markers may be used for upstream bursts (e.g., bursts 420 and 422, FIGS. 4A-4B) but not for downstream bursts.

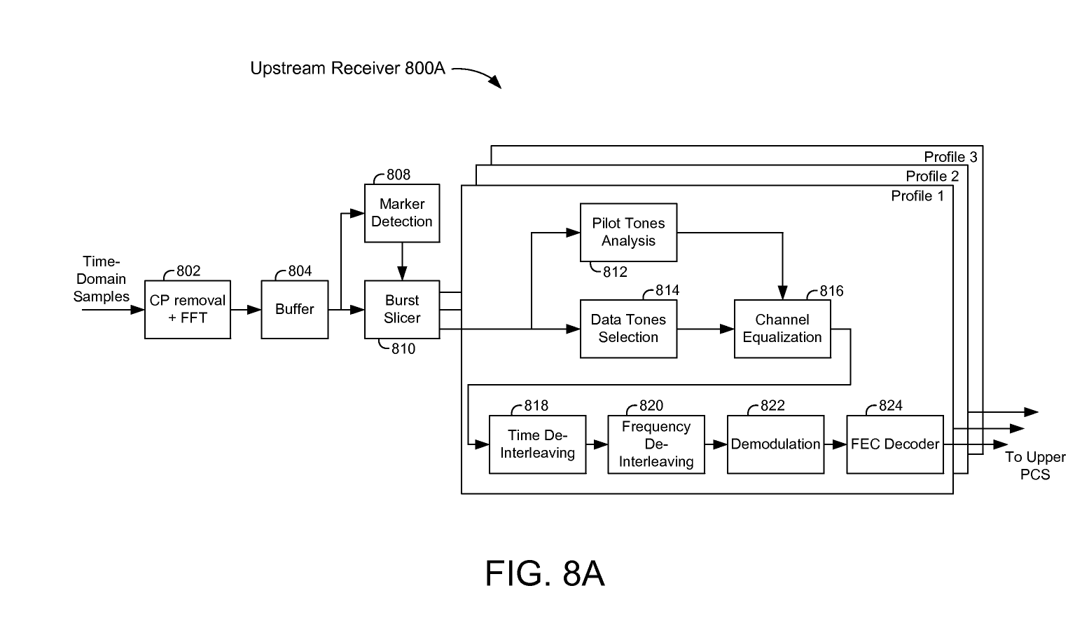

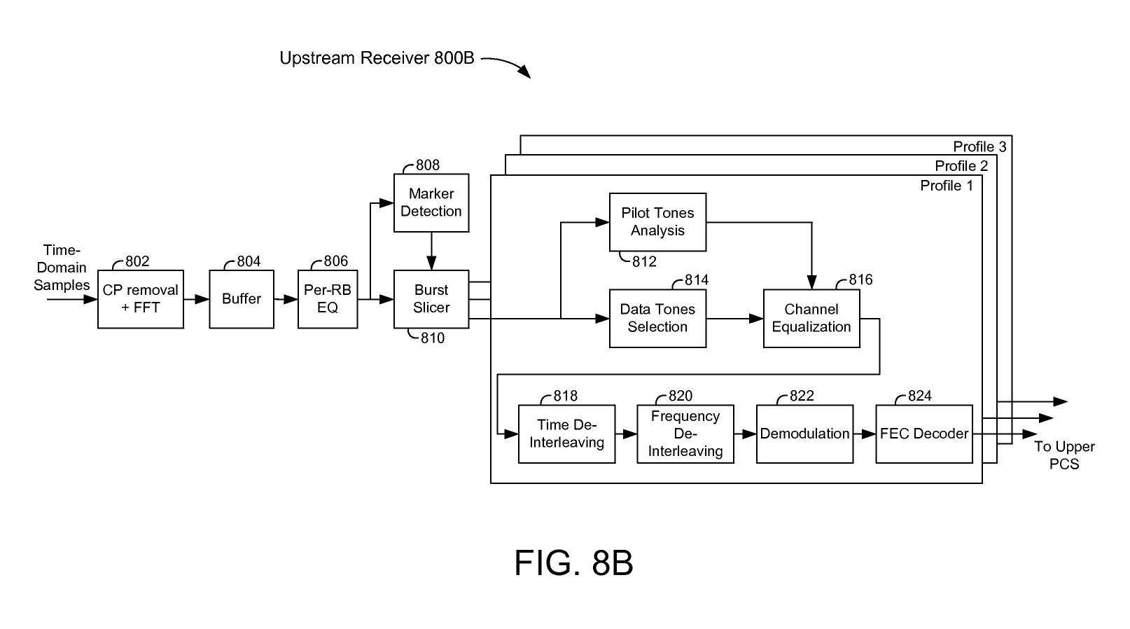

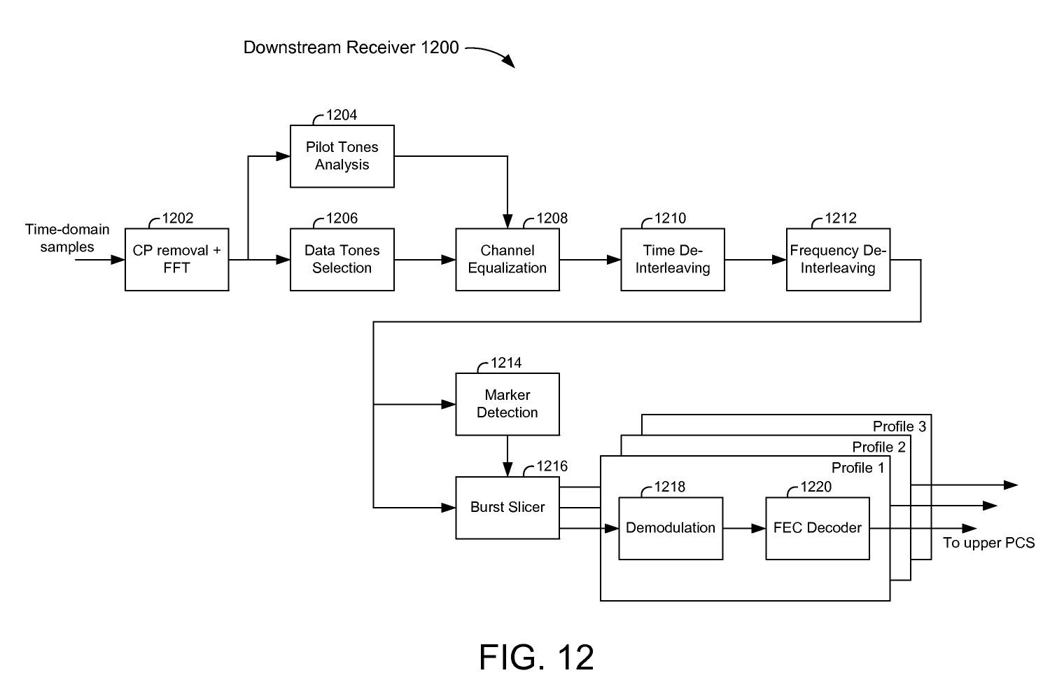

Marker detection is performed with a correlator (e.g., in a marker detection module 808, FIGS. 8A-8B, and a marker detection module 1214, FIG. 12) that evaluates the correlation between received samples r[l] within a particular observation window of length L and each of the possible marker symbols sᵢ[l]:

Σₗ₌₀^{L}r[l]·sᵢ*[l] (8)

where sᵢ*[l] is the complex conjugate of sᵢ[l]. The received samples r[l] are the output samples of the block (i.e., module) within the baseband processing chain coming before marker detection in a particular receiver implementation. For example, the received samples r[l] are the output samples of the buffer 804 (FIG. 8A), per-resource-block equalizer 806 (FIG. 8B), or frequency de-interleaver 1212 (FIG. 12). If equalization is performed before marker detection, the received samples r[l] are the output of the channel equalization block (e.g., the channel equalizer 1208, FIG. 12) and may also have been subjected to time and/or frequency de-interleaving. In some embodiments, the correlator decides in favor of the candidate marker yielding the highest correlation. In other embodiments, markers are identified by determining whether candidate markers satisfy a predefined criterion. For example, a candidate marker is identified as a marker if the corresponding correlation is greater than, or greater than or equal to, a predefined detection threshold. Use of a predefined detection threshold accounts for the possibility of no marker being present.

If the marker symbols 404 are taken from a ternary alphabet, correlation is performed once the square of the received marker symbols 404 is taken (i.e., after non-coherent detection). The correlation for marker symbols 404 using a ternary alphabet is thus determined using the formula

Σₗ₌₀^{L}|r[l]|²·|sᵢ*[l]|² (9)

(For differential QPSK, correlation is performed after differential demodulation.) If marker symbols 404 are generated from a marker sequence via differential phase modulation, correlation is performed after de-rotation of the received samples (i.e., after differential demodulation):

$$[ \begin{matrix}\frac{r [ 0 ] \cdot {r}_{p}^{*}}{{\vert {r}_{p} \vert}^{2}} & r [ 1 ] \cdot {r}^{*} [ 0 ] & … & r [ L - 2 ] \cdot {r}^{*} [ L - 3 ] & r [ L - 1 ] \cdot {r}^{*} [ L - 2 ]\end{matrix} ] \qquad ( 10 )$$

where rₚ is the signal received at the location of the reference for the differential phase modulation.

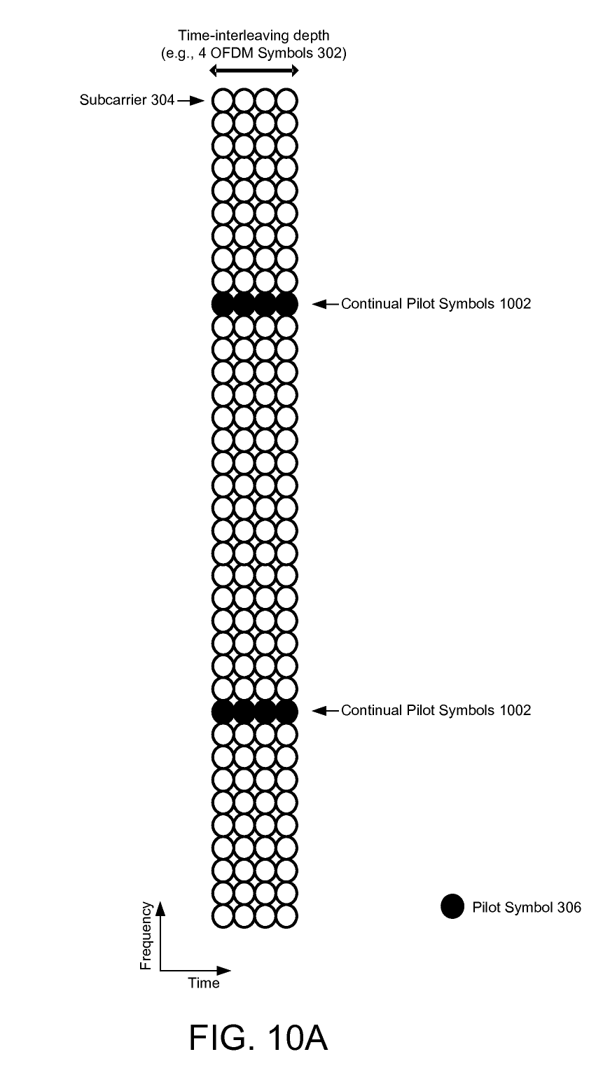

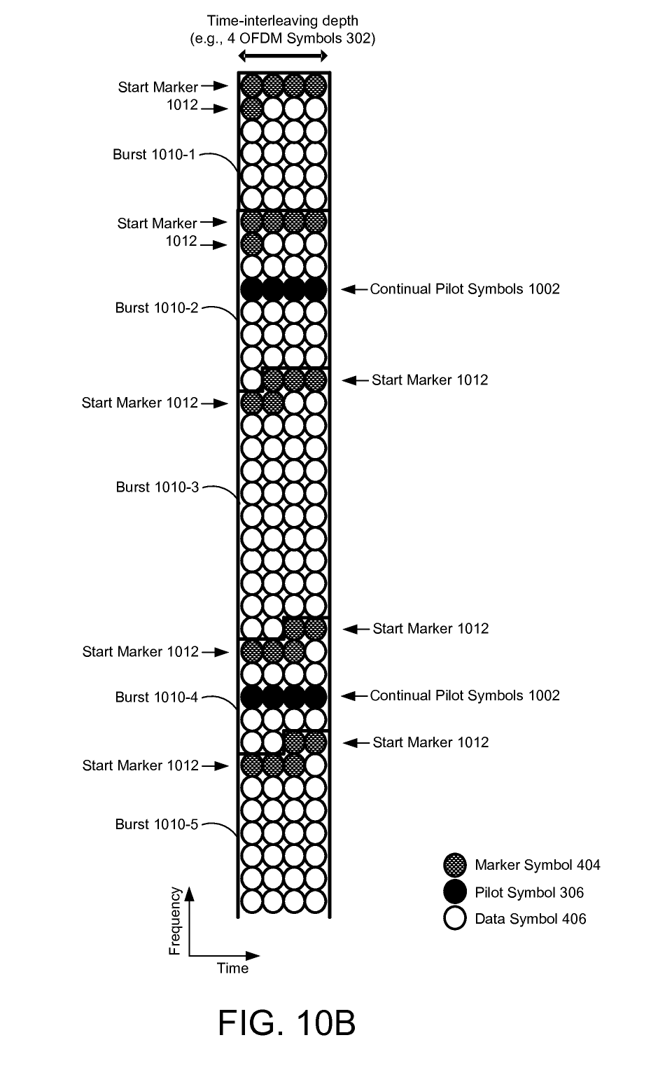

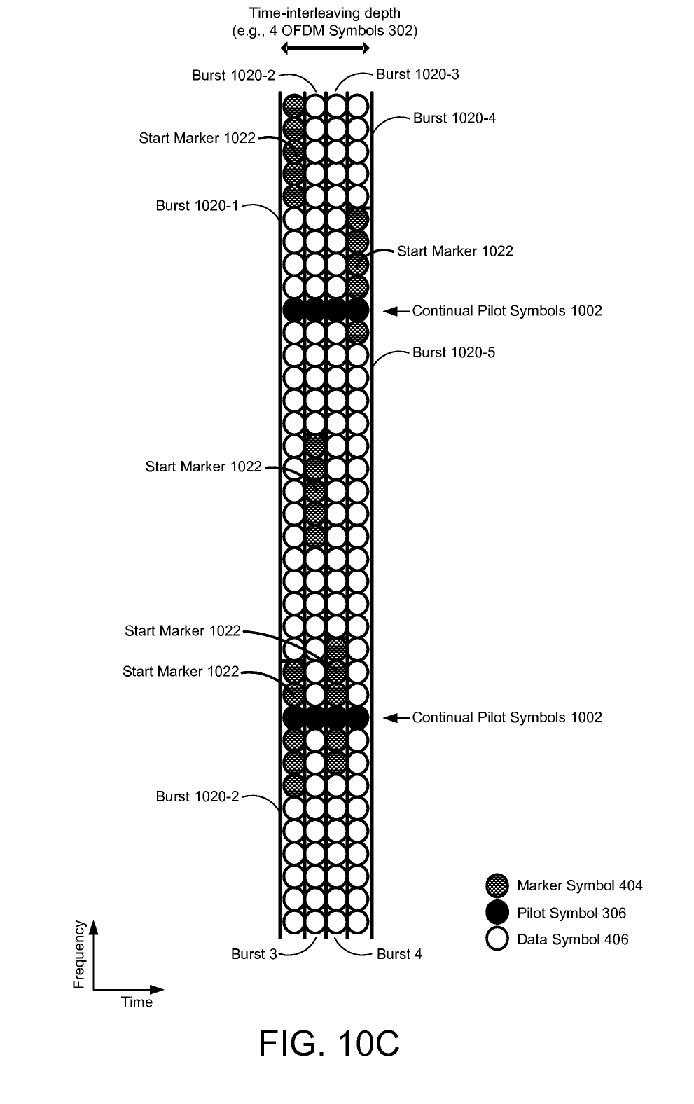

Marker symbols 404 are placed such that they do not overwrite pilot symbols 306. The marker symbols 404 and pilot symbols 306 are independent. The pilot symbols 306 are located in predictable locations. For upstream transmissions using resource blocks (e.g., resource blocks 300, FIG. 3A, or 310, FIGS. 3B-3C), the marker symbols 404 are also located in predictable locations. For downstream transmissions that do not use resource blocks (e.g., as shown in FIGS. 10B and 100, below), the marker symbols 404 are not located in predictable locations.

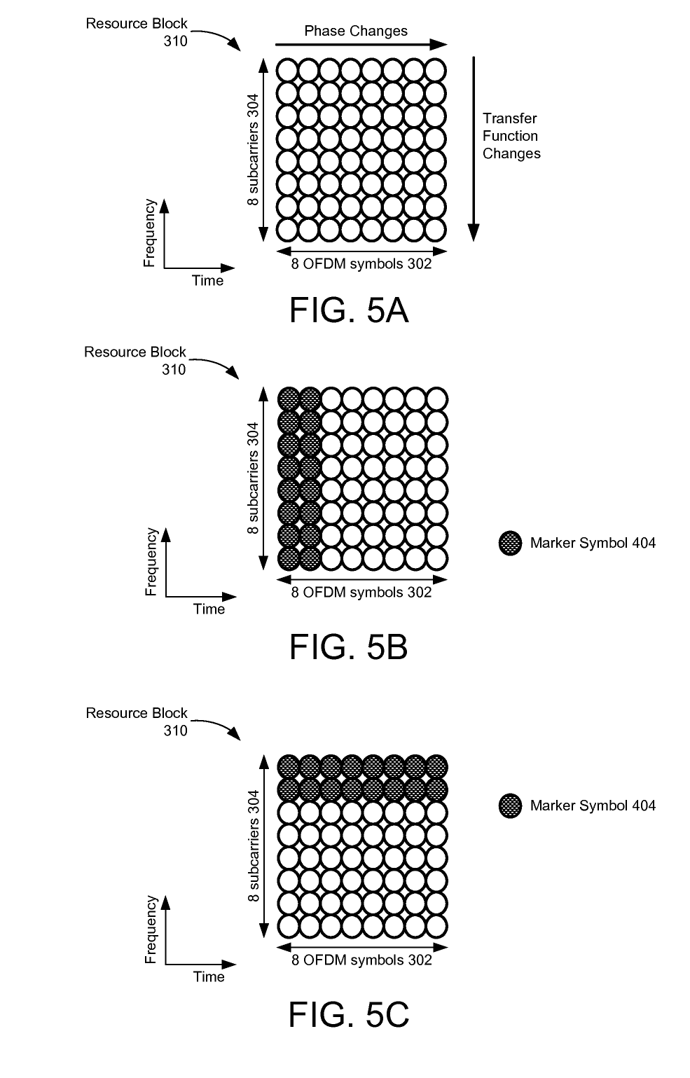

Marker symbol placement may be selected to provide robustness against channel distortion (e.g., channel distortion that is not pre-equalized in the transmitter). Examples of channel distortion include phase changes in time (e.g., due to local oscillator instability in the transmitter) and transfer function changes in frequency (e.g., due to front-end sensitivity to environmental parameters). As shown in FIG. 5A, phase changes occur across successive OFDM symbols 302 in a resource block (e.g., resource block 310, FIGS. 3B-3C), while transfer function changes occur across different subcarriers 304 in a resource block. Marker symbols 404 for start and end markers may be grouped by OFDM symbol 302 (“vertical placement”) to reduce or minimize the effect of phase changes on marker detection, as shown in FIG. 5B. Alternatively, marker symbols 404 for start and end markers may be grouped by subcarrier 304 (“horizontal placement”) to reduce or minimize the effect of transfer function changes on marker detection, as shown in FIG. 5C. Grouping marker symbols 404 by subcarrier 304 allows the marker symbols 404 to serve as continual pilot symbols, if the marker symbols 404 span every OFDM symbol 302 in a subcarrier 304 of a resource block (e.g., as shown in FIGS. 4A-4B). In general, after marker sequences have been detected, marker symbols 404 can be used as known reference signals in the same manner as pilot symbols 306. Using start and end markers as pilot symbols placed at the edges of a burst/grant avoids extrapolation of the channel estimate at the edges of the burst/grant and provides time and phase tracking capabilities. Markers that may serve as pilot symbols are not included in unused resource blocks, because the unused resource blocks are not allocated to any CNUs 140; therefore, no CNU 140 transmits in the unused resource blocks.

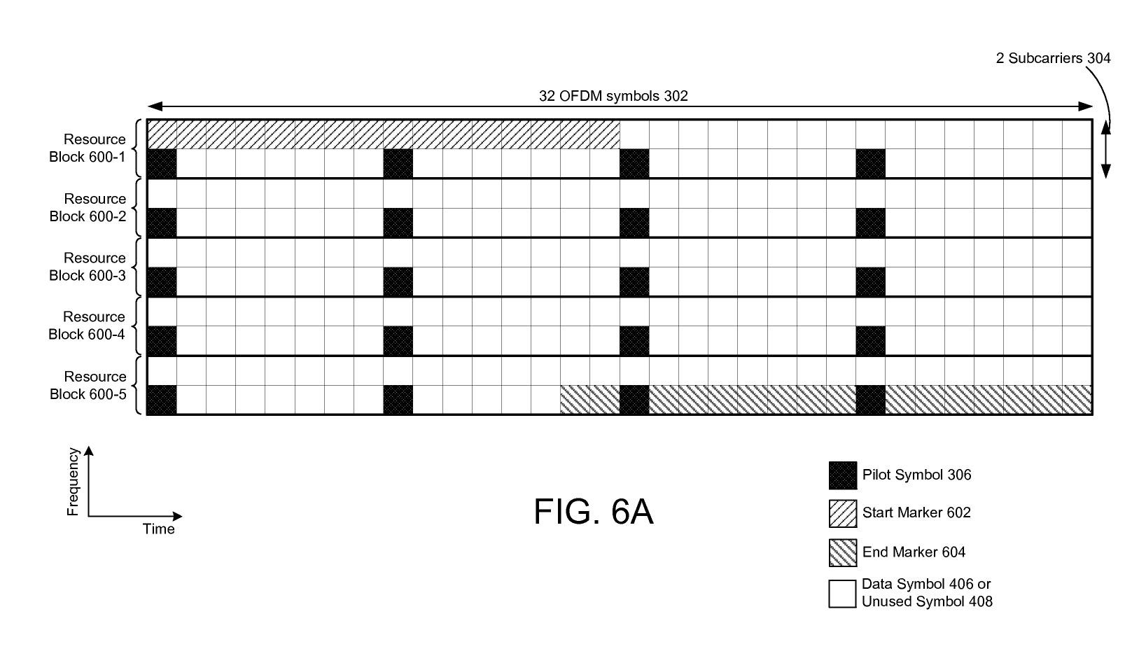

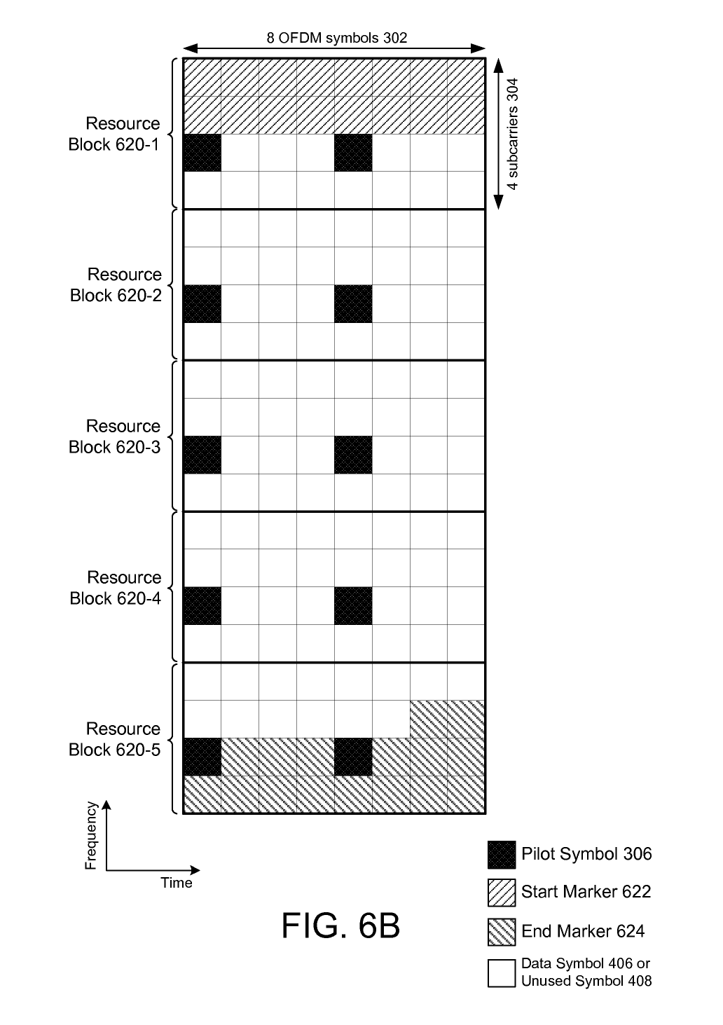

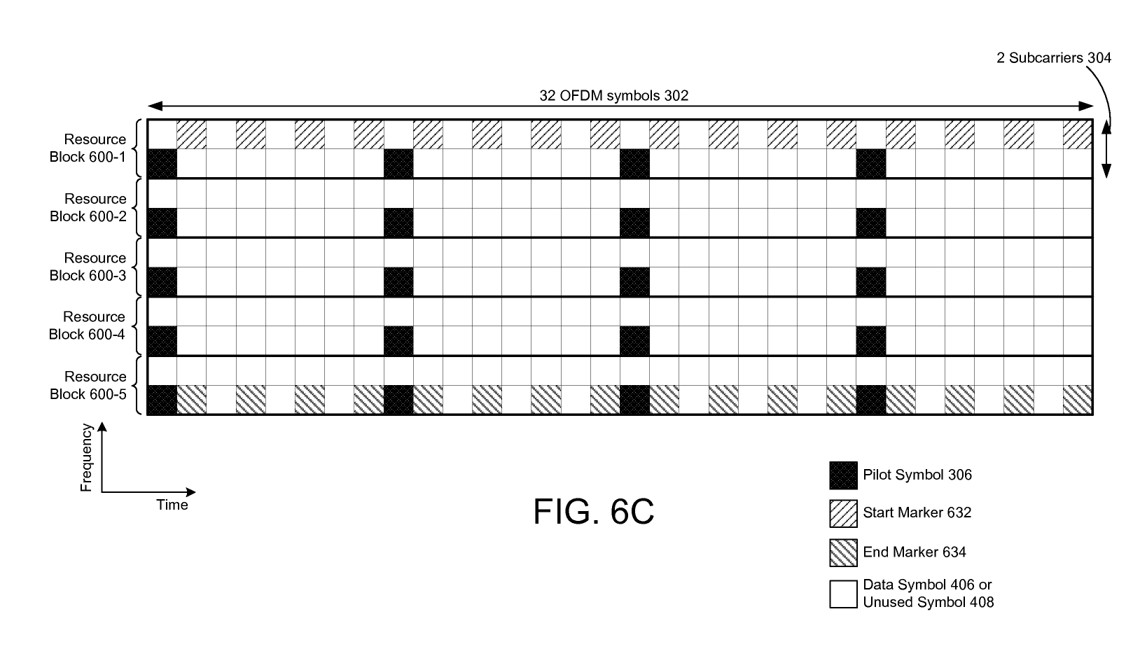

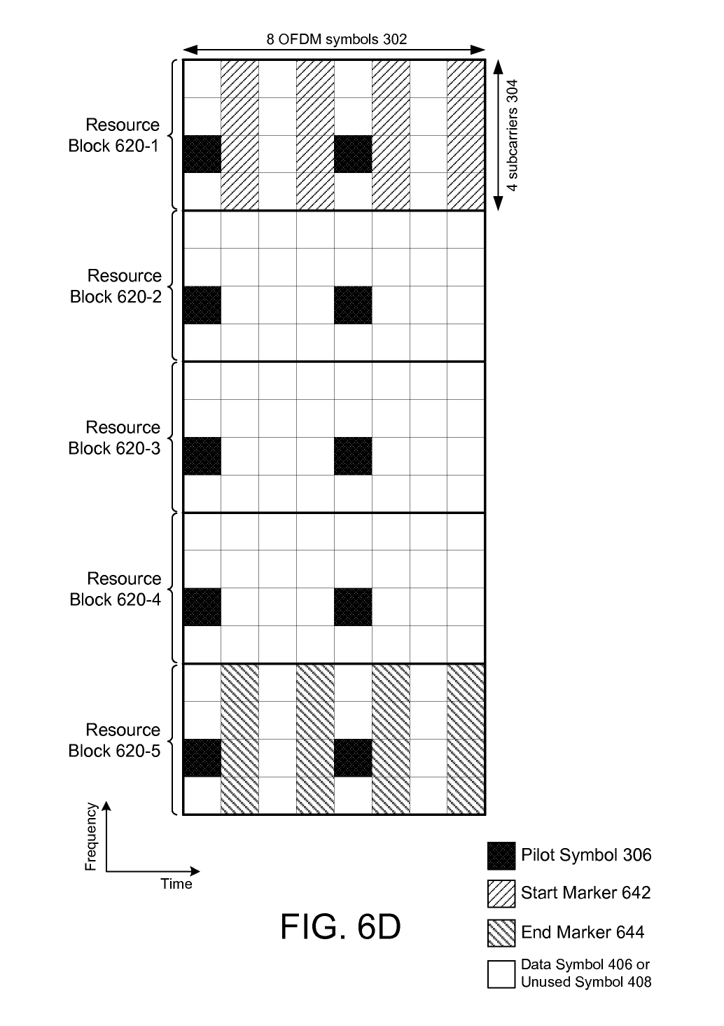

FIGS. 6A-6D show additional examples of marker placement in accordance with some embodiments. In FIG. 6A, a grant allocates resource blocks 600-1 through 600-5 to a particular CNU 140 for a burst. In this example, the specified number of resource elements for the markers is less than the number of OFDM symbols 302 in the resource blocks 600-1 through 600-5 and thus in the (sub)frame. Also, the markers are placed such that they do not overwrite any pilot symbols 306. Accordingly, a start marker 602 is placed on a subset of the resource elements in the top subcarrier 304 of resource block 600-1 and an end marker 604 is placed on a subset of the resource elements in the bottom subcarrier 304 of resource block 600-5. In some embodiments, the resource elements for the start marker 602 are grouped together, as are the resource elements for the end markers 604. For example, the resource elements for the start marker 602 are grouped in successive OFDM symbols 302, while the resource elements for the end marker 604 are grouped in a manner that does not overwrite any pilot symbols 306 (e.g., are grouped in adjacent available resource elements). Evenly spaced pilot symbols 306 are included as shown.

In FIG. 6B, a grant allocates resource blocks 620-1 through 620-5 to a particular CNU 140 for a burst. In this example, the specified number of resource elements for the markers is greater than the number of OFDM symbols 302 in the resource blocks 620-1 through 620-5 and thus in the (sub)frame. Also, the markers are placed such that they do not overwrite any pilot symbols 306. Accordingly, markers are placed on multiple subcarriers 304 at the beginning and end of the grant. A start marker 622 is placed in all the resource elements for the top two subcarriers 304 of resource block 620-1. An end marker 624 is placed in all the resource elements for the bottom two subcarriers 304 of resource block 620-5 except for the resource elements that carry pilot symbols 306. Because there are two pilot symbols 306 in the second subcarrier 304 from the bottom of resource block 620-5, marker symbols 404 for the end marker 624 are also placed in two resource elements (e.g., corresponding to two successive OFDM symbols 302) in the third subcarrier 304 from the bottom of resource block 620-5. Evenly spaced regular pilot symbols 306 are included in the burst/grant as shown.

In FIG. 6C, a grant again allocates resource blocks 600-1 through 600-5 to a particular CNU 140 for a burst. In this example, the specified number of resource elements for the markers is less than the number of OFDM symbols 302 in the resource blocks 600-1 through 600-5. The same OFDM symbols 302 are used for the start marker 632 and end marker 634. The marker symbols 404 of the start marker 532 and end marker 634 are interleaved with data symbols 406 (or unused symbols 408) in the top and bottom subcarriers 304 of the burst.

In FIG. 6D, a grant again allocates resource blocks 620-1 through 620-5 to a particular CNU 140 for a burst. Marker symbols 404 for a start marker 642 and an end marker 644 are interleaved with data symbols 406 (or unused symbols 408) in multiple subcarriers 304 at both the beginning and end of the burst/grant (e.g., in the first four subcarriers 304 and last four subcarriers 304 of the burst). The start marker 642 and end marker 644 are placed on the same OFDM symbols 302.

In FIGS. 6A and 6B, the start and end markers are asymmetric. In FIGS. 6C and 6D, the start and end markers are symmetric.

Other examples of marker placement besides those of FIGS. 6A-6D are possible. For example, the OFDM symbols 302 used for the start marker may be staggered (e.g., interleaved) with the OFDM symbols 302 used for the end marker. In some embodiments, the start and/or end markers are replicated (e.g., to create a symmetric pattern and/or continual pilots). For example, the start marker 602 and end marker 604 (FIG. 6A) may be replicated such that every resource element of the first and last subcarriers 304 of the burst has a marker symbol 404 (or pilot symbol 306), resulting in effective continual pilots at the burst edges.

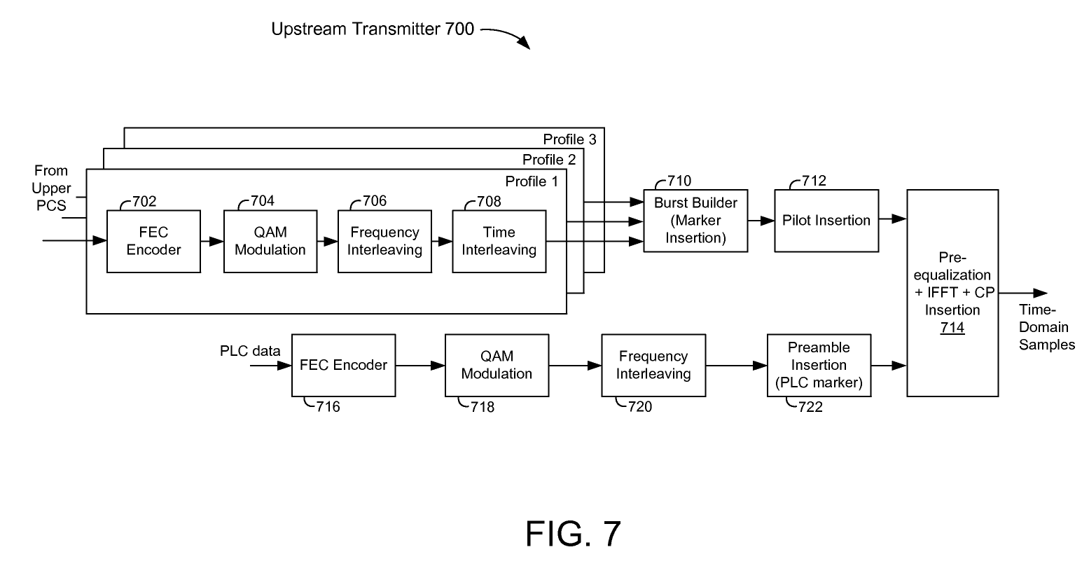

FIG. 7 is a block diagram of an upstream transmitter 700 (e.g., in the coax PHY 224 of the CNU 140, FIG. 2) in accordance with some embodiments. The transmitter 700 performs includes a separate forward error correction (FEC) encoder 702, QAM modulator 704, frequency interleaver 706, timer interleaver 708 for each profile. The transmitter 700 therefore performs separate FEC encoding, QAM modulation, frequency interleaving, and time interleaving for each profile. The frequency interleaver 706 and time interleaver 708 perform frequency and time interleaving separately for each burst. The order of the frequency interleaver 706 and time interleaver 708, and thus of time and frequency interleaving, may be reversed. A burst builder 710 inserts markers and assembles OFDM symbols 302. In some embodiments, the burst builder 710 assembles respective OFDM symbols 302 from multiple bursts, such that an OFDM symbol 302 may include multiple bursts (e.g., corresponding to multiple respective profiles) or portions of multiple bursts transmitted by the same CNU 140. A pilot insertion module 712 inserts pilot symbols 306 after marker insertion and burst construction by the burst builder 710. In some embodiments, the pilot symbols 306 are independent of profile and of the CNU 140. For example, the inserted pilot symbols 306 are determined based on the frequency resources (e.g., subcarriers 304) occupied by the burst(s) being transmitted.

A module 714 in the upstream transmitter 700 may perform pre-equalization (e.g., based on a channel estimate determined by the CLT 162 and communicated to the CNU 140), as well as implementing an Inverse Fast Fourier Transform (IFFT) and inserting a cyclic prefix (CP). In some embodiments, the module 714 implements the IFFT and performs CP insertion but does not perform pre-equalization.

User data from upper sublayers of a physical coding sublayer (PCS) (e.g., in the coax PHY 224, FIG. 2) is multiplexed with PHY link channel (PLC) data as shown. The PLC is a control channel used to communicate PHY parameters between the CNU 140 and CLT 162. An FEC encoder 716 encodes the PLC data, a QAM modulator 718 modulates the encoded PLC data, a frequency interleaver 720 performs frequency interleaving on the modulated, encoded PLC data, and a preamble insertion module 722 inserts a preamble, which is also referred to as a PLC marker. The preamble insertion module 722 provides its output to the module 714.

FIG. 8A is a block diagram of an upstream receiver 800A (e.g., in the coax PHY 212 of the CLT 162, FIG. 2) in accordance with some embodiments. The upstream receiver 800A performs marker search after performing cyclic prefix removal and a Fast Fourier Transform (FFT) on the input time-domain samples in a module 802 and buffering the transformed samples in a buffer 804. This buffering may be performed in blocks equal to the time-interleaving depth. Marker search is performed by a marker detection module 808, which provides its output to a burst slicer 810. The burst slicer 810 performs burst slicing on the transformed samples from the buffer 804 and provides its output to a pilot tones analysis module 812 and a data tones selection module 814. The pilot tones analysis module 812 performs channel estimation using the pilot symbols. The channel estimate is provided to a channel equalizer 816, which performs equalization on the output of the data tones selection module 814 based on the channel estimate. A time de-interleaver 818 and frequency de-interleaver 820 then perform frequency and time de-interleaving. The order of the time de-interleaver 818 and frequency de-interleaver 820, and thus of the time and frequency de-interleaving, may be reversed. The upstream receiver 800A performs channel estimation, channel equalization, frequency de-interleaving, and time de-interleaving separately for each burst (e.g., separately for each profile), after burst slicing has occurred.

FIG. 8B is a block diagram of an alternative upstream receiver 800B (e.g., in the coax PHY 212 of the CLT 162, FIG. 2) in accordance with some embodiments. The upstream receiver 800B includes a per-resource-block equalizer (Per-RB EQ) 806 coupled between the buffer 804 on one side and the marker detection module 808 and burst slicer 810 on the other side. The per-resource-block equalizer 806 generates initial approximate channel estimates for respective resource blocks and performs equalization on a resource-block-by-resource-block basis using the initial approximate channel estimates. This initial equalization conditions and thereby facilitates marker detection. Channel equalization is performed again by the channel equalizer 816 after marker detection and burst slicing, based on the channel estimate generated by the pilot tones analysis module 812.

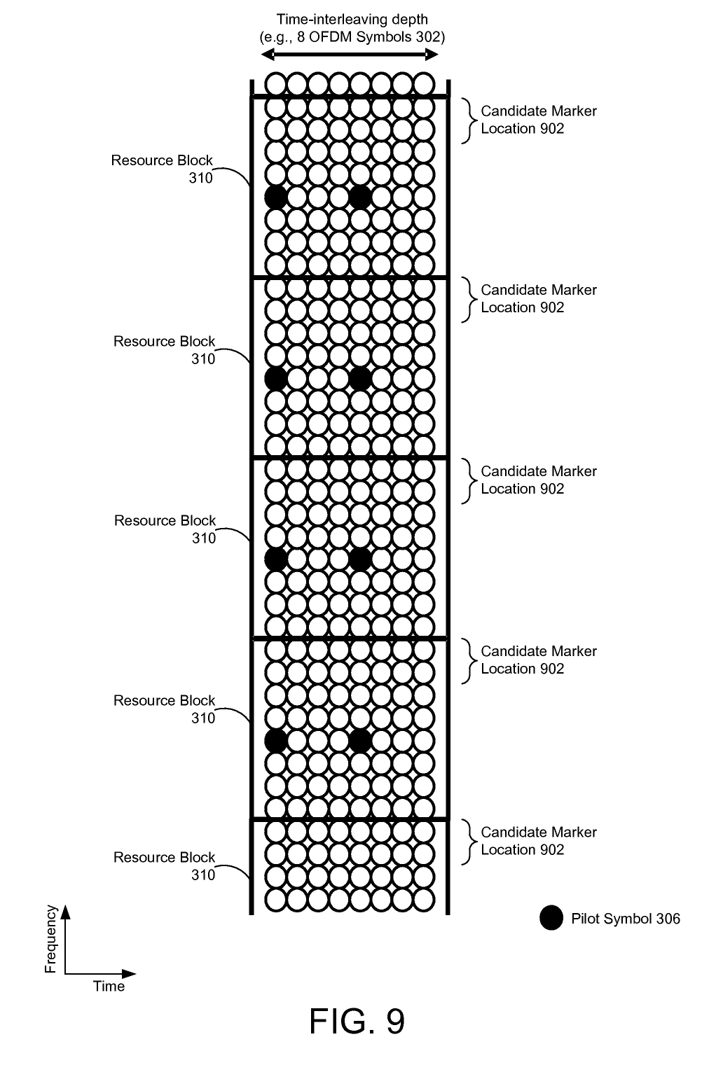

FIG. 9 shows an example of marker detection in accordance with some embodiments. In this example, the marker detection module 808 (FIGS. 8A-8B) scans candidate marker locations 902 in which start markers potentially could be located (e.g., in each resource block 310). These potential start marker locations are referred to as candidate marker locations 902. For example, if start markers are placed on the top two subcarriers 304 of the first resource block in a burst (e.g., as shown in FIGS. 4A, 4B, and 5C), then the marker detection module 808 scans the first two subcarriers 304 of each resource block, as shown for the resource blocks 310 in FIG. 9. Once a start marker is detected, the marker detection module 808 then scans for an end marker by scanning all candidate end marker locations.

Attention is now directed to downstream transmissions from a CLT 162 to CNUs 140. In some embodiments, downstream transmissions include continual pilot symbols 1002 on specified subcarriers 304, as shown in FIG. 10A in accordance with some embodiments. Continual pilot symbols 1002 occur where specified subcarriers 304 include pilot symbols 306 in every OFDM symbol 302 of a downstream transmission. In some embodiments, the continual pilot symbols 1002 are symmetric about the DC subcarrier. The CNUs 140 use the continual pilot symbols 1002 for channel estimation and tracking. Non-continual pilot symbols 306 may also be included in downstream transmissions in accordance with some embodiments. For example, the regularly spaced pilot symbols 306 of FIGS. 4A and 4B may also be included in downstream transmissions. In another example, non-continual pilot symbols 306 may be scattered across multiple subcarriers 304 and OFDM symbols 302 (e.g., in a diagonal pattern).

FIG. 10B shows bursts 1010-1 through 1010-5 in a downstream transmission in accordance with some embodiments. (FIG. 10B is an example of a portion of a frame before time de-interleaving is performed. Frequency interleaving is neglected in FIG. 10B for simplicity.) Each of the bursts 1010-1 through 1010-5 may be directed to a respective CNU 140 (or to a respective logical link identifier (LLID) associated with one or more CNUs 140). In some embodiments resource blocks are not used for downstream transmissions, as FIG. 10B shows. The bursts 1010-1 through 1010-5 and their associated start markers 1012 are therefore not aligned to a grid of resource elements. Instead, the bursts 1010-1 through 1010-5 follow each other back-to-back and are continuous across available resource elements (e.g., neglecting resource elements used for pilot symbols 306). Furthermore, end markers may be omitted. The start markers 1012 for the bursts 1010-1 through 1010-5 include a specified number of marker symbols 404 (e.g., five start marker symbols 404 in FIG. 10B), as described for upstream transmission.

In FIG. 10B, the bursts 1010-1 through 1010-5 use resource elements grouped by subcarrier 304. Respective bursts of the bursts 1010-1 through 1010-5 wrap from the last OFDM symbol 302 of a subcarrier 304 to the first OFDM symbol 302 of the next subcarrier 304. The start markers 1012 are placed horizontally. Alternatively, bursts 1020-1 through 1020-5 use resource elements grouped by OFDM symbol 302, as shown in FIG. 10C in accordance with some embodiments. Respective bursts of the bursts 1020-1 through 1020-5 may wrap from the bottom subcarrier 304 of an OFDM symbol 302 to the top subcarrier 304 of the next OFDM symbol 302, as shown for bursts 1020-2, 1020-3, and 1020-4 in FIG. 100. In FIG. 100, the start markers 1022 for the bursts 1010-1 through 1010-5 are placed vertically. (FIG. 100 depicts a portion of a frame after time de-interleaving is performed, or a portion of a frame for which time interleaving is not performed. FIG. 100 thus corresponds to a symbol stream on which the marker detection module 1214 in the downstream receiver 1200 of FIG. 12 operates.)

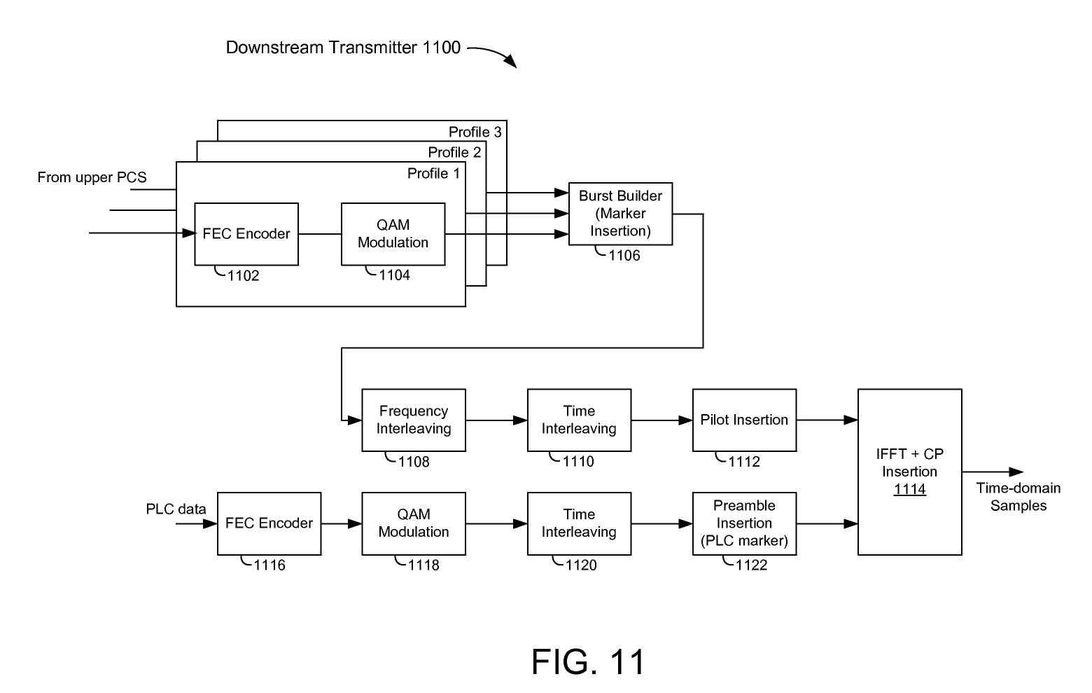

FIG. 11 is a block diagram of a downstream transmitter 1100 (e.g., in the coax PHY 212 of the CLT 162, FIG. 2) in accordance with some embodiments. FEC encoding and QAM modulation are performed separately for each profile. For example, the transmitter 1100 includes a separate FEC encoder 1102 and QAM modulator 1104 for each profile. A burst builder 1106 receives modulated symbols from the QAM modulators 1104 for the different profiles and generates a continual modulated symbol stream. The burst builder 1106 also performs marker insertion. A frequency interleaver 1108 and time interleaver 1110 perform frequency and time interleaving over the continual modulated symbol stream from the burst builder 1106. The order of the frequency interleaver 1108 and time interleaver 1110, and thus of time and frequency interleaving, may be reversed. A pilot insertion module 1112 inserts pilot symbols 306 after frequency and time interleaving, after which a module 1114 performs IFFT processing and cyclic prefix (CP) insertion. User data from upper PCS sublayers is multiplexed with PLC data as shown: the transmitter includes an FEC encoder 1116, QAM modulator 1118, time interleaver 1120 and preamble insertion module 1122 that are analogous to the FEC encoder 716, QAM modulator 718, frequency interleaver 720, and preamble insertion module 722 of the upstream transmitter 700 (FIG. 7). The PLC is a control channel used to communicate PHY parameters between the CLT 162 and CNU 140.

FIG. 12 is a block diagram of a downstream receiver 1200 (e.g., in the coax PHY 224 of the CNU 140, FIG. 2) in accordance with some embodiments. A module 1202 receives time-domain samples, performs cyclic prefix removal, and performs an FFT. Channel estimation, channel equalization, frequency de-interleaving, and time de-interleaving are performed after the FFT and are burst-agnostic. The output of the module 1202 is provided to a pilot tones analysis module 1204 and a data tones selection module 1206. The pilot tones analysis module 1204 performs channel estimation based on pilot symbols. A channel equalizer 1208 performs equalization on the output of the data tones selection module 1206, based on the channel estimation from the pilot tones analysis module 1204. Channel equalization is performed for both data symbols 406 and marker symbols 404. A time de-interleaver 1210 and frequency de-interleaver 1212 perform time and frequency de-interleaving to re-ordering modulated symbols. (Time interleaving and de-interleaving may be block-based, as in the examples of FIGS. 10B and 10C, or convolutional in accordance with some embodiments.) The order of the time de-interleaver 1210 and frequency de-interleaver 1212, and thus of time and frequency de-interleaving, may be reversed. A marker detection module 1214 performs marker detection after channel estimation, channel equalization, frequency de-interleaving, and time de-interleaving, and before demodulation and FEC decoding. Marker detection is a running correlation performed over the stream of re-ordered modulated symbols. In some embodiments, marker detection does not use additional buffering. A burst slicer 1216 performs burst slicing on the stream of re-ordered modulated symbols based on the detected markers, and provides its output to respective demodulators 1218 and FEC decoders 1220. The receiver 1200 performs demodulation and FEC decoding on a profile-by-profile basis, and thus may include a separate demodulator 1218 and FEC decoder 1220 for each profile.

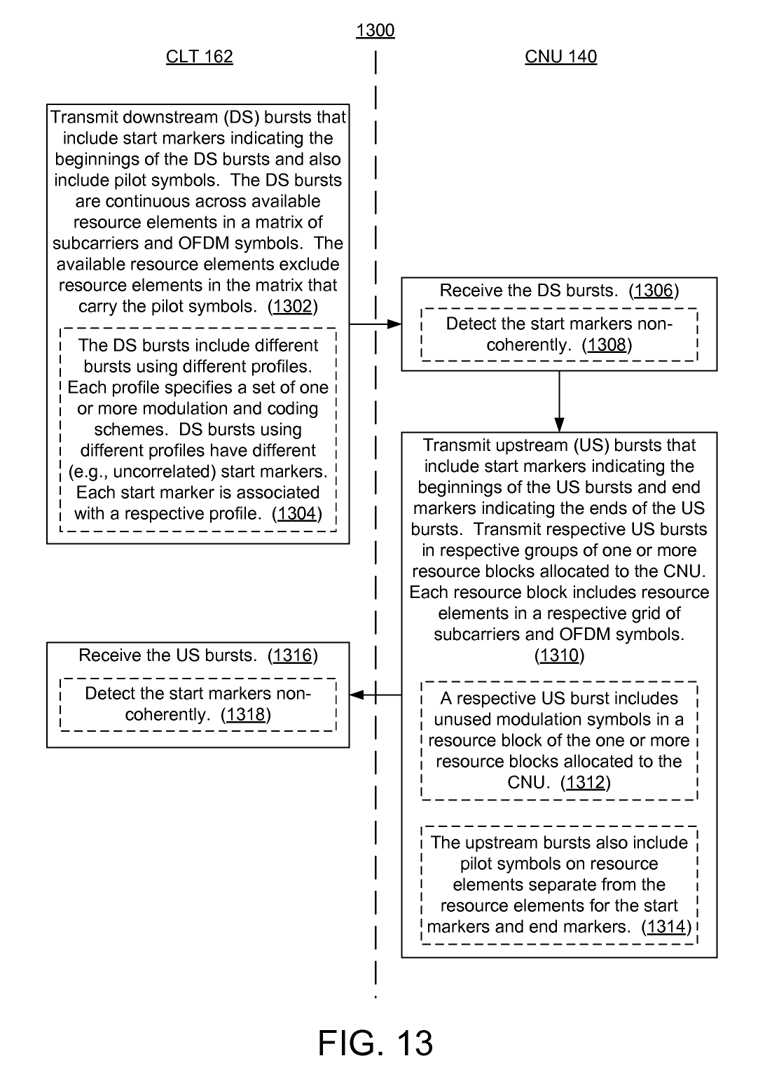

FIG. 13 is a flowchart showing a method 1300 of communication between a CLT 162 and CNU 140 (e.g., in a network 100 or 105, FIGS. 1A-1B, which may include a system 200, FIG. 2) in accordance with some embodiments. The CLT 162 transmits (1302) downstream bursts (e.g., bursts 1010-1 through 1010-5, FIG. 10B, or bursts 1020-1 through 1020-5, FIG. 10C) that include start markers (e.g., start markers 1012 or 1022, FIGS. 10B-10C) indicating the beginnings of the downstream bursts and also include pilot symbols 306 (e.g., continual pilot symbols 1002, FIGS. 10A-10C). The downstream bursts are continuous across available resource elements in a matrix of subcarriers 304 and OFDM symbols 302. The available resource elements exclude those resource elements in the matrix that carry the pilot symbols 306.

In some embodiments, the start markers in the downstream bursts include marker symbols 404 grouped by OFDM symbol 302 (e.g., as shown in FIG. 100). Alternatively, the start markers in the downstream bursts include marker symbols 404 grouped by subcarrier 304 (e.g., as shown in FIG. 10B). In some embodiments, the downstream bursts do not include end markers (e.g., as shown in FIGS. 10B-10C).

In some embodiments, the downstream bursts include (1304) different bursts using different profiles. Each profile specifies a set of one or more modulation and coding schemes. Downstream bursts using different profiles have different start markers. For example, the different start markers are uncorrelated (e.g., in accordance with one or more of Equations 4-7). Each start marker is associated with a respective profile.

The CNU 140 receives (1306) the downstream bursts. (Different ones of the downstream bursts may be directed to different CNUs 140) In some embodiments, the CNU 140 detects (1308) the start markers non-coherently. For example, a marker detection module 1214 (FIG. 12) determines whether a correlation between a known marker and received samples in a specified window satisfies a criterion. The correlation is determined, for example, using Equation 8 or 9.

The CNU 140 transmits (1310) upstream bursts (e.g., bursts 402 or 422, FIGS. 4A-4B) that include start markers indicating the beginnings of the US bursts and end markers indicating the ends of the US bursts. Respective upstream bursts are transmitted in respective groups of one or more resource blocks (e.g., resource blocks 300 or 310, FIGS. 3A-3C) allocated to the CNU 140. Each resource block includes resource elements in a respective grid of subcarriers 304 and OFDM symbols 302. A respective upstream burst may include (1312) unused symbols 408 in a resource block of the one or more resource blocks allocated to the CNU 140.

In some embodiments, respective start markers and end markers of the upstream bursts include marker symbols grouped by OFDM symbol 302 (e.g., as shown in FIG. 5B). Alternatively, respective start markers and end markers of the upstream bursts include marker symbols grouped by subcarrier 304 (e.g., as shown in FIG. 5C).

In some embodiments, a start marker (e.g., start marker 602 or 622, FIGS. 6A-6B) of a respective upstream burst includes marker symbols situated on successive available resource elements in one or more initial subcarriers 304 of the respective upstream burst. An end marker (e.g., end marker 604 or 624, FIGS. 6A-6B) of the respective upstream burst includes marker symbols situated on successive available resource elements in one or more final subcarriers 304 of the respective upstream burst.

In some embodiments, a start marker (e.g., start marker 632 or 642, FIGS. 6C-6D) of a respective upstream burst includes marker symbols in one or more initial subcarriers 304 of the respective upstream burst. An end marker (e.g., end marker 634 or 644, FIGS. 6C-6D) of the respective upstream burst includes marker symbols in one or more final subcarriers 304 of the respective upstream burst. The marker symbols 404 in the one or more initial subcarriers 304 and the one or more final subcarriers 304 are interleaved with data symbols 406 (and/or with unused symbols 408).

In some embodiments, the upstream bursts also include (1314) pilot symbols 306 on resource elements that are separate from the resource elements used for the start markers and end markers.

The CLT 162 receives (1316) the upstream bursts. In some embodiments, the CLT 162 detects (1318) the start markers non-coherently. For example, a marker detection module 808 (FIGS. 8A-8B) determines whether a correlation between a known marker and received samples in a specified window satisfies a criterion. In another example, the marker detection module 808 (FIGS. 8A-8B) identifies a candidate marker (e.g., in a candidate marker location 902, FIG. 9) that has a highest correlation with a known marker. The correlation is determined, for example, using Equation 8 or 9.

While the method 1300 includes a number of operations that appear to occur in a specific order, it should be apparent that the method 1300 can include more or fewer operations, which can be executed serially or in parallel. An order of two or more operations may be changed, performance of two or more operations may overlap, and two or more operations may be combined into a single operation.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of data communication, comprising:
at a coax network unit (CNU) coupled to a coax line terminal (CLT):
receiving from the CLT downstream bursts comprising start markers indicating the beginnings of the downstream bursts and further comprising pilot symbols, wherein:
the downstream bursts are continuous across available resource elements in a matrix of subcarriers and orthogonal frequency-division multiplexing (OFDM) symbols, and
the available resource elements exclude resource elements in the matrix that carry the pilot symbols.

2. The method of claim 1, wherein the start markers comprise marker symbols grouped by OFDM symbol.

3. The method of claim 1, wherein the start markers comprise marker symbols grouped by subcarrier.

4. The method of claim 1, wherein the downstream bursts omit end markers.

5. The method of claim 1, further comprising, at the CNU, detecting the start markers non-coherently.

6. The method of claim 5, wherein the detecting comprises determining whether a correlation between received samples in a specified window and a known marker satisfies a criterion.

7. The method of claim 1, wherein:
the downstream bursts comprise different bursts using different profiles, wherein each profile specifies a set of one or more modulation and coding schemes; and
downstream bursts using different profiles comprise different start markers, wherein each start marker is associated with a respective profile.

8. The method of claim 7, wherein the different start markers are uncorrelated.

9. The method of claim 1, further comprising, at the CNU, transmitting to the CLT upstream bursts comprising start markers indicating the beginnings of the upstream bursts and end markers indicating the ends of the upstream bursts, wherein:
respective upstream bursts are transmitted in respective groups of one or more resource blocks allocated to the CNU; and
each resource block comprises resource elements in a respective grid of subcarriers and OFDM symbols.

10. The method of claim 9, wherein a respective upstream burst comprises unused resource elements in a resource block of the one or more resource blocks allocated to the CNU.

11. The method of claim 9, wherein:
the upstream bursts further comprise pilot symbols; and
the pilot symbols of the upstream bursts use separate resource elements than the start markers and end markers of the upstream bursts.

12. The method of claim 9, wherein respective start markers and end markers of the upstream bursts comprise marker symbols grouped by OFDM symbol.

13. The method of claim 9, wherein respective start markers and end markers of the upstream bursts comprise marker symbols grouped by subcarrier.

14. The method of claim 9, wherein:
a start marker of a respective upstream burst comprises marker symbols situated on successive available resource elements in one or more initial subcarriers of the respective upstream burst; and
an end marker of the respective upstream burst comprises marker symbols situated on successive available resource elements in one or more final subcarriers of the respective upstream burst.

15. The method of claim 9, wherein:
a start marker of a respective upstream burst comprises marker symbols in one or more initial subcarriers of the respective upstream burst;
an end marker of the respective upstream burst comprises marker symbols in one or more final subcarriers of the respective upstream burst; and
the marker symbols in the one or more initial subcarriers and the one or more final subcarriers are interleaved with data symbols.

16. A CNU, comprising a receiver to receive downstream bursts that comprise start markers indicating the beginnings of the downstream bursts and further comprise pilot symbols, wherein:
the downstream bursts are continuous across available resource elements in a matrix of subcarriers and OFDM symbols; and
the available resource elements exclude resource elements in the matrix that carry the pilot symbols.

17. The CNU of claim 16, wherein the receiver comprises a marker detection module to detect the start markers non-coherently.

18. The CNU of claim 17, wherein the receiver further comprises:
a pilot tones analysis module to perform channel estimation based on the pilot symbols; and
a channel equalizer to perform equalization based on the channel estimation;
wherein an output of the channel equalizer is coupled to an input of the marker detection module.

19. The CNU of claim 18, wherein the receiver further comprises a time de-interleaving module and a frequency de-interleaving module coupled between the output of the channel equalizer and the input of the marker detection module.

20. The CNU of claim 16, further comprising a transmitter to transmit upstream bursts comprising start markers indicating the beginnings of the upstream bursts and end markers indicating the ends of the upstream bursts, wherein:
respective upstream bursts are transmitted in respective groups of one or more resource blocks allocated to the CNU; and
each resource block comprises resource elements in a respective grid of subcarriers and OFDM symbols.

21. The CNU of claim 20, wherein the transmitter comprises a burst builder to assemble the upstream bursts and insert the start markers and end markers into the upstream bursts.

22. The CNU of claim 20, wherein:
the burst builder is to insert the start markers and the end markers into the upstream bursts on specified resource elements; and
the transmitter further comprises a pilot insertion module to insert pilot symbols into the upstream bursts on resource elements separate from the specified resource elements.

23. A CNU, comprising:
means for receiving downstream bursts that comprise start markers indicating the beginnings of the downstream bursts and further comprise pilot symbols, wherein:
the downstream bursts are continuous across available resource elements in a matrix of subcarriers and OFDM symbols; and
the available resource elements exclude resource elements in the matrix that carry the pilot symbols.

24. The CNU of claim 23, wherein the means for receiving the downstream bursts comprise means for detecting the start markers non-coherently.

25. The CNU of claim 24, wherein the means for receiving the downstream bursts further comprise:
means for performing channel estimation based on the pilot symbols; and
means for performing equalization based on the channel estimation.

26. The CNU of claim 23, further comprising:
means for transmitting upstream bursts comprising start markers indicating the beginnings of the upstream bursts and end markers indicating the ends of the upstream bursts, wherein:
respective upstream bursts are transmitted in respective groups of one or more resource blocks allocated to the CNU; and
each resource block comprises resource elements in a respective grid of subcarriers and OFDM symbols.

27. The CNU of claim 26, wherein the means for transmitting the upstream bursts comprise:
means for inserting the start markers and end markers into the upstream bursts on specified resource elements; and
means for inserting pilot symbols into the upstream bursts on resource elements separate from the specified resource elements.
